(19) United States
(12) Patent Application Publication
(10) Pub. No.: US 2024/0018335 A1
(43) Pub. Date: Jan. 18, 2024

(54) ZINC OXIDE PARTICLES, METHOD FOR PRODUCING ZINC OXIDE PARTICLES, AND RESIN COMPOSITION

(71) Applicant: DIC Corporation, Tokyo (JP)

(72) Inventors: Jianjun Yuan, Sakura-shi (JP); Takayuki Kanematsu, Sakura-shi (JP); Akeo Takahashi, Sakura-shi (JP); Masaki Iida, Sakura-shi (JP)

(73) Assignee: DIC Corporation, Tokyo (JP)

(21) Appl. No.: 18/026,154

(22) PCT Filed: Sep. 28, 2021
(86) PCT No.: PCT/JP2021/035599

§ 371 Date: Mar. 14, 2023

(30) Foreign Application Priority Data
Oct. 2, 2020 (JP) 2020-167633

(51) Int. Cl. C08K 3/22; C01G 9/03

(52) U.S. Cl. CPC C08K 3/22; C01G 9/03; C01P 2002/60; C01P 2004/62; C01P 2004/61; C01P 2004/30; C01P 2006/22; C01P 2004/03; C01P 2002/72; C08K 2201/005; C08K 2003/2296

(57) ABSTRACT

Zinc oxide particles having a polyhedron shape, wherein the crystallite diameter of the [100] plane of the zinc oxide particles is 200 nm or greater. A method for producing the zinc oxide particles, the method including firing a zinc compound in the presence of a molybdenum compound. A resin composition containing the zinc oxide particles and a resin.

### TECHNICAL FIELD

The present invention relates to zinc oxide particles, a method for producing the zinc oxide particles, and a resin composition.

The present application claims a priority based on Japanese Patent Application No. 2020-167633, filed in Japan on Oct. 2, 2020, the contents of which are hereby incorporated herein by reference.

### BACKGROUND ART

Conventionally, smaller, lighter, and higher-performance devices have been required, and with this requirement, higher integration and larger capacity of semiconductor devices have been developed. Therefore, the amount of heat generated in the components of the devices has been increased and improvement in heat dissipation function of the devices has been required. As methods for improving the heat dissipation function of devices, for example, a method for providing thermal conductivity to insulating members, or more specifically, for adding heat dissipating fillers having high thermal conductivity to resins serving as insulating members has been known. In this method, for example, particles of alumina (aluminum oxide), magnesium oxide, boron nitride, aluminum nitride, and magnesium carbonate may be exemplified as the heat dissipation fillers to be used.

Aluminum oxide particles and magnesium oxide particles are the most widespread heat dissipating fillers. The aluminum oxide particles, however, have high hardness (Mohs hardness: 9) and thus may wear the metal of mixers and molding machines. In contrast, magnesium oxide has not so high hardness (Mohs hardness: 6), but has a problem in water resistance, and thus is difficult for wide application. Therefore, fillers have been required that can reduce the risk of wearing counterpart metal materials and have excellent water resistance while having higher thermal conductivity than that of the aluminum oxide particles and the magnesium oxide particles.

In contrast, zinc oxide fine particles have a wide range of applications and are used as, for example, vulcanization accelerators for rubbers, printing inks, paints, catalysts, and pigments. In recent years, zinc oxide fine particles have been expected as a heat dissipating filler due to high thermal conductivity of zinc oxide. Zinc oxide has a Mohs hardness of 4 to 5 and is softer than aluminum oxide.

For example, PTL 1 has disclosed that heating a mixture of a zinc acetate compound and methanol results in precipitating zinc oxide fine particles having particularly large crystallite anisotropy.

PTL 2 has disclosed that zinc oxide nanoparticles are generated by introducing zinc vapor into an oxygen-containing plasma region.

PTL 3 has disclosed that ultrafine zinc oxide particles are generated by calcining zinc compounds.

### CITATION LIST

### Patent Literature

PTL 1: Japanese Unexamined Patent Application No. 2003-034529
PTL 2: Japanese Unexamined Patent Application No. 2005-213067
PTL 3: Japanese Unexamined Patent Application No. 2007-297260

### SUMMARY OF INVENTION

### Technical Problem

The average particle sizes of the zinc oxide particles disclosed in PTLs 1 to 3, however, are 100 nm or less and crystallite diameter is also 100 nm or less and thus excellent crystallinity and excellent thermal conductivity have not been expected.

Therefore, an object of the present invention is to provide zinc oxide particles having a larger crystallite diameter and more excellent thermal conductivity than those of conventional zinc oxide particles, a method for producing the same, and a resin composition.

### Solution to Problem

The present invention includes the following aspects.

[1] A zinc oxide particle having a polyhedral shape, in which a crystallite diameter of a [100] plane of the zinc oxide particle is 200 nm or more.
[2] The zinc oxide particle as described in [1], in which a crystallite diameter of a [101] plane of the zinc oxide particle is 250 nm or more.
[3] The zinc oxide particle as described in [1] or [2], in which a median diameter D₅₀ of the zinc oxide particle calculated by a laser diffraction and scattering method is 0.1 μm to 100 μm.
[4] The zinc oxide particle as described in any one of [1] to [3], in which a dispersion index S calculated by the following formula (1) from a 10% diameter D₁₀, a median diameter D₅₀, and a 90% diameter D₉₀ calculated by a laser diffraction and scattering method is 2.0 or less:

S=(D₉₀−D₁₀)/D₅₀ (1).

[5] A method for producing the zinc oxide particle as described in any one of [1] to [4], the method including: calcining a zinc compound in the presence of a molybdenum compound.
[6] The method for producing the zinc oxide particle as described in [5], including mixing the zinc compound and a molybdate compound to form a mixture and calcining the mixture.
[7] The method for producing the zinc oxide particle as described in claim 6, in which the molybdate compound is lithium molybdate, potassium molybdate, or sodium molybdate.
[8] A resin composition containing the zinc oxide particle as described in any one of [1] to [4] and a resin.
[9] The resin composition as described in [8], in which the resin is a thermoplastic resin.

### Advantageous Effects of Invention

The present invention can provide the zinc oxide particle having a larger crystallite diameter and more excellent thermal conductivity than those of conventional zinc oxide particles, the method for producing the same, and the resin composition.

### BRIEF DESCRIPTION OF DRAWINGS

FIG. 1 is a SEM photograph of zinc oxide particles in Example 1.

FIG. 2 is a SEM photograph of zinc oxide particles in Example 2.

FIG. 3 is a SEM photograph of zinc oxide particles in Example 3.

FIG. 4 is a SEM photograph of zinc oxide particles in Example 4.

FIG. 5 is a SEM photograph of zinc oxide particles in Example 5.

FIG. 6 is a SEM photograph of zinc oxide particles in Example 6.

FIG. 7 is a SEM photograph of zinc oxide particles in Comparative Example 1.

FIG. 8 is a SEM photograph of zinc oxide particles in Comparative Example 2.

FIG. 9 is an X-ray diffraction (XRD) pattern of the zinc oxide particles in Example 1.

### DESCRIPTION OF EMBODIMENTS

<Zinc Oxide Particles>

The zinc oxide particles according to the present embodiment are zinc oxide particles having a polyhedral shape, in which the crystallite diameter of the [100] plane of the zinc oxide particles is 200 nm or more.

In the present specification, the crystallite diameter of the [100] plane of the zinc oxide particles adopts a value of the crystallite diameter calculated using the Scherrer formula from the full width at half maximum (FWHM) of the peak attributed to the [100] plane (that is, the peak appearing around 2θ=31.8°) measured using an X-ray diffraction method (XRD method).

The crystallite diameter of the [100] plane of the zinc oxide particles according to the present embodiment is 200 nm or more, preferably 220 nm or more, more preferably 240 nm or more, and further preferably 260 nm or more. The crystallite diameter of the [100] plane of the zinc oxide particles according to the present embodiment may be 600 nm or less, may be 500 nm or less, may be 400 nm or less, or may be 340 nm or less. The crystallite diameter of the [100] plane of the zinc oxide particles according to the present embodiment may be 200 nm or more and 600 nm or less, preferably 220 nm or more and 500 nm or less, more preferably 240 nm or more and 400 nm or less, and further preferably 260 nm or more and 340 nm or less.

The zinc oxide particles according to the present embodiment have a polyhedral shape. Having a polyhedral shape allows surface contact between particles in the resin compound when the zinc oxide particles according to the present embodiment are used as an additive to the resin compound, and thus an excellent improving effect in the thermal conductivity of the resin compound is provided. In the present specification, the “polyhedral shape” means a shape of hexahedron or more, preferably octahedron or more, and more preferably decahedron to triacontahedron. The zinc oxide particles according to the present embodiment have a polyhedral shape formed by a flux method described below and thus form a single-crystal structure. The single-crystal structure reduces phonon scattering and improves thermal conductivity.

The zinc oxide particles according to the present embodiment have a polyhedral shape and an area of the largest flat surface in the primary particle of the zinc oxide particles is a quarter or less, preferably a fifth or less, more preferably a sixth or less, and further preferably an eighth or less relative to the area of the polyhedral particles. When the area of the largest flat surface is a quarter or less relative to the area of the polyhedral particles, the shape of the zinc oxide particles is a polyhedron that is virtually close to a sphere, which facilitates resin filling and is advantageous for improving the thermal conductivity of the resin compound. The above “area of the largest flat surface” and “area of polyhedral particles” can be estimated from SEM photographs.

The zinc oxide particles according to the present embodiment have a large crystallite diameter of the [100] plane and high crystallinity, resulting in excellent thermal conductivity.

The zinc oxide particles according to the present embodiment preferably have a crystallite diameter of the [101] plane of 250 nm or more, more preferably 260 nm or more, and further preferably 270 nm or more. The zinc oxide particles according to the present embodiment may have a crystallite diameter of the [101] plane of 500 nm or less, 400 nm or less, or 320 nm or less. The zinc oxide particles according to the present embodiment preferably have a crystallite diameter of the [101] plane of 250 nm or more and 500 nm or less, more preferably 260 nm or more and 400 nm or less, and further preferably 270 nm or more and 320 nm or less.

In the present specification, the crystallite diameter of the [101] plane of the zinc oxide particles employs the value of the crystallite diameter calculated using the Scherrer formula from the full width at half maximum (FWHM) of the peak attributed to the [101] plane (that is, the peak appearing around 2θ=36.3°) measured using an X-ray diffraction method (XRD method).

The zinc oxide particles according to the present embodiment having a crystallite diameter of 200 nm or more of the [100] plane and a crystallite diameter of 250 nm or more of the [101] plane have high crystallinity and are more excellent in the thermal conductivity.

The median diameter D₅₀ of the zinc oxide particles according to the present embodiment calculated by a laser diffraction and scattering method is preferably 0.1 μm to 100 μm, preferably 0.5 μm to 100 μm, more preferably 1.0 μm to 60 μm, and further preferably 2.0 μm to 40 μm.

The dispersion index S of the zinc oxide particles according to the present embodiment determined by the following formula (1) from the 10% diameter D₁₀, the median diameter D₅₀, and the 90% diameter D₉₀ calculated by the laser diffraction and scattering method is preferably 2.0 or less, more preferably 1.8 or less, and further preferably 1.6 or less.

S=(D₉₀−D₁₀)/D₅₀ (1)

The 10% diameter D₁₀, the median diameter D₅₀, and the 90% diameter D₉₀ are calculated by the laser diffraction and scattering method. Specifically, a laser diffraction particle size distribution analyzer, for example, a laser diffraction particle size distribution meter HELOS (H3355) & RODOS, R3: 0.5/0.9-175 μm (manufactured by Nippon Laser Co., Ltd.) is used to measure the particle size distribution in a dry method under a dispersion pressure of 3 bar and a pull pressure of 90 mbar, whereby the 10% diameter D₁₀, the median diameter D₅₀, and the 90% diameter D₉₀ can be determined.

The zinc oxide particles according to the present embodiment having a dispersion index S of 2.0 or less, when used as an additive in a resin compound, facilitate resin filling design. The zinc oxide particles having a dispersion index S of 2.0 or less tend to have larger crystallite diameters of the [100] plane and the [101] plane, resulting in high crystallinity of the zinc oxide particles and an excellent improving effect in the thermal conductivity of the resin compound.

The zinc oxide particles according to the present embodiment may include molybdenum.

The amount of molybdenum determined by XRF analysis is preferably 0% by mass to 5.0% by mass, more preferably 0% by mass to 3.0% by mass, and further preferably 0% by mass to 1.0% by mass relative to 100% by mass of the zinc oxide particles.

The zinc oxide particles according to the present embodiment may further include lithium, potassium, or sodium.

The average diameter of the primary particles of the zinc oxide particles may be 0.1 μm to 100.0 μm, may be 0.2 μm to 50.0 μm, or may be 0.5 μm to 20.0 μm.

The average diameter of the primary particles of the zinc oxide particles refers to an average value of the primary particle diameters of randomly selected 50 primary particles when the zinc oxide particles are photographed using a scanning electron microscope (SEM), a longer diameter (a Feret's diameter of the observed longest part) and a shorter diameter (a short Feret's diameter perpendicular to this Feret's diameter of the longest part) are measured with respect to the smallest unit of particles (that is, the primary particles) constituting agglomerates on the two-dimensional image, and the average value is determined to be the primary particle diameter.

The specific surface area of the zinc oxide particles measured by the BET method may be 0.01 m²/g to 10.0 m²/g, 0.02 m²/g to 5.0 m²/g, or 0.05 m²/g to 2.0 m²/g.

<Method for Producing Zinc Oxide Particles>

The method for producing according to the present embodiment is a method for producing the zinc oxide particles and includes calcining a zinc compound in the presence of a molybdenum compound.

The method for producing the zinc oxide particles according to the present embodiment can increase the crystallite diameter of the [100] plane of the zinc oxide particles by calcining the zinc compound in the presence of the molybdenum compound, whereby the zinc oxide particles can have a polyhedral shape.

A preferable method for producing the zinc oxide particles includes a step of mixing the zinc compound and the molybdenum compound to form a mixture (a mixing step) and a step of calcining the mixture (a calcining step).

A more preferable method for producing the zinc oxide particles includes a step of mixing the zinc compound and a molybdate compound, in which the molybdenum compound is the molybdate compound, to form a mixture (a mixing step), and a step of calcining the mixture (a calcining step).

[Mixing Step]

The mixing step is a step of mixing the zinc compound and the molybdenum compound to form a mixture. The mixing step is preferably a step of mixing the zinc compound and the molybdate compound to form a mixture. Hereinafter, the contents of the mixture will be described.

(Zinc Compound)

The zinc compound is not limited as long as the compound can turn into zinc oxide by calcining. Examples of the zinc compound include zinc oxide, zinc acetate, and zinc hydroxide. Zinc oxide is preferable as the zinc compound.

(Molybdenum Compound)

Examples of the molybdenum compound include molybdenum oxide and molybdate compounds.

Examples of the molybdenum oxide include molybdenum dioxide and molybdenum trioxide, and molybdenum trioxide is preferable.

The molybdate compound is not limited as long as the molybdate compound is salt compounds of molybdenum oxoanions such as MoO₄²⁻, Mo₂O₇²⁻, Mo₃O₁₀²⁻, Mo₄O₁₃²⁻, Mo₅O₁₆²⁻, Mo₆O₁₉²⁻, Mo₇O₂₄⁶⁻, and Mo₈O₂₆⁴⁻. The molybdate compound may be alkali metal salts of molybdenum oxoanions, that is, alkali metal salts of molybdate, may be alkaline earth metal salts of molybdate, or may be ammonium molybdate salts.

Examples of the alkali metal salts of molybdate include potassium molybdates such as K₂MoO₄, K₂Mo₂O₇, K₂Mo₃O₁₀, K₂Mo₄O₁₃, K₂Mo₅O₁₆, K₂Mo₆O₁₉, K₆Mo₇O₂₄, and K₄Mo₈O₂₆; sodium molybdates such as Na₂MoO₄²⁻, Na₂Mo₂O₇²⁻, Na₂Mo₃O₁₀²⁻, Na₂Mo₄O₁₃²⁻, Na₂Mo₅O₁₆²⁻, Na₂Mo₆O₁₉²⁻, Na₆Mo₇O₂₄⁶⁻, and Na₄Mo₈O₂₆⁴⁻; and lithium molybdates such as Li₂MoO₄, Li₂Mo₂O₇, Li₂Mo₃O₁₀, Li₂Mo₄O₁₃, Li₂Mo₅O₁₆, Li₂Mo₆O₁₉, Li₆Mo₇O₂₄, and Li₄Mo₈O₂₆.

The alkali metal molybdate salts are preferable as the molybdate compounds, and lithium molybdates, potassium molybdates, or sodium molybdates are more preferable.

The alkali metal molybdate salts do not vaporize in the calcination temperature range and can be easily recovered by washing after calcining, and thus the amount of the molybdenum compounds released outside the calcination furnace is reduced and the production cost can be significantly reduced.

In the method for producing the zinc oxide particles according to the present embodiment, when the molybdate compound is the alkali metal salt, the molybdenum compound and the alkali metal compound can be regarded as existing under the calcining conditions of the mixture of the zinc compound and the alkali metal molybdate salt. The molybdenum compounds (such as molybdenum oxide) react with the alkali metal compounds (such as alkali metal carbonates, alkali hydroxides, alkali metal nitrates, or alkali metal oxides) to form the alkali metal molybdate salts. The alkali metal molybdate salts serve as both fluxing agents and shape control agents.

In the method for producing the zinc oxide particles according to the present embodiment, the molybdate compounds may be hydrated compounds.

In the method for producing the zinc oxide particles according to the present embodiment, the molybdenum compounds are used as the fluxing agents. In the present specification, hereinafter, this method for producing using the molybdenum compound as the fluxing agent is simply referred to as a “flux method”.

With such calcining, it can be considered that the molybdenum compound interacts with the zinc compound to form the zinc oxide particles having a polyhedral shape under the action of the flux of the molybdenum compound.

In the method for producing the zinc oxide particles according to the present embodiment, the blend amounts of the zinc compound and the molybdate compound are not particularly limited. However, preferably a zinc compound of 35% by mass or more and a molybdate compound of 65% by mass or less relative to the mixture of 100% by mass are mixed to prepare a mixture, and the mixture can be calcined. More preferably, a zinc compound of 40% by mass or more and 99% by mass or less and a molybdate compound of 0.5% by mass or more and 60% by mass or less relative to zinc oxide particles of 100% by mass are mixed to prepare a mixture, and the mixture can be calcined. Still more preferably, a zinc compound of 45% by mass or more and 95% by mass or less and a molybdate compound of 2% by mass or more to 55% by mass or less are mixed relative to zinc oxide particles of 100% by mass to prepare a mixture, and the mixture can be calcined.

Use of various compounds within the above range allows the polyhedral shape of the obtained zinc oxide particles to be favorably formed, and the zinc oxide particles having a crystallite diameter of the [100] plane of 200 nm or more can be produced.

[Calcining Step]

The calcining step is a step of calcining the mixture. The zinc oxide particles according to the embodiment are obtained by calcining the above mixture. As described above, the method for producing is called the flux method.

The flux method is classified as a solution method. More specifically, the flux method refers to a method of crystal growth that utilize the fact that the crystal-flux two-component state diagram indicates a eutectic type. The mechanism of the flux method is presumed to be as follows. Namely, as the solute and flux mixture is heated, the solute and the flux turn into a liquid phase. At this time, the flux is a melting agent, in other words, the solute-flux two-component state diagram indicates the eutectic type, so that the solute melts at a temperature lower than its melting point and the liquid phase is formed. When the flux is evaporated in this state, the concentration of the flux decreases, in other words, the melting point lowering effect of the solute by the flux is reduced and the crystal growth of the solute occurs due to flux evaporation acting as driving force (a flux evaporation method). The solute and the flux can also cause the crystal growth of the solute by cooling the liquid phase (a slow cooling method).

The flux method has advantages in that the crystal can be grown at temperatures further lower than the melting point, the crystal structure can be precisely controlled, and a polyhedral-shaped crystal having a self-shaped single-crystal structure can be formed.

In the production of the zinc oxide particles by the flux method using the molybdate compound as the flux, although the mechanism of the method is not necessarily clear, the mechanism is assumed to be based on the following mechanism, for example. Namely, when the zinc compound is calcined in the presence of the molybdate compound, the molybdate compound interacts with the zinc compound to grow zinc oxide crystals at a lower temperature than the melting point of zinc oxide, as can be understood from the above description. For example, functioning the molybdate compound as a flux action and a shape control agent by calcining at a high temperature allows the crystal growth of zinc oxide to be controlled and thus zinc oxide particles having a polyhedral shape according to the embodiment to be obtained. In other words, the molybdate compound acts as both of the fluxing agent and the shape control agent to produce the zinc oxide particles.

The above flux method allows the zinc oxide particles having a polyhedral shape and a crystallite diameter of the [100] plane of 200 nm or more to be produced. The zinc oxide particles obtained from the method for producing by the flux method have the polyhedral shape and thus form the single crystal structure. In addition, the zinc oxide particles may include molybdenum.

A method for calcining is not particularly limited and can be performed by any known and customary methods. The calcination temperature exceeding 650° C. allows the interaction between the zinc compound and the molybdate compound to be generated. Furthermore, the calcination temperature being 800° C. or more allows the zinc oxide particles to be formed by using the molybdate compound as the flux agent and the shape control agent.

At the time of calcining, the state of the zinc compound and the molybdate compound is not particularly limited as long as the molybdate compound exists in the same space where the molybdate compound can act on the zinc compound. Specifically, simple mixing, mechanical mixing using a grinder or the like, or mixing using a mortar or the like for mixing powders of the molybdate compound and the zinc compound, or powders of molybdenum oxide, the alkali metal compound, and the zinc compound may be employed and mixing in a dry state or a wet state may be employed.

The conditions of the calcination temperature are not particularly limited and determined as appropriate depending on the average particle diameter of the target zinc oxide particles, formation of the molybdenum compound in the zinc oxide particles, dispersibility, and the like. Usually, the calcination temperature is preferably 800° C. or more, which is close to the lowest temperature at which the desired zinc oxide particles can be formed.

Usually, when the shape of the zinc oxide obtained after calcining is tried to control, high temperature calcining is required to perform at a temperature of 1,500° C. or more, which is close to the melting point of the zinc oxide. From the viewpoint of the load on the calcination furnace and fuel costs, however, there is a major challenge for industrial use.

The method for producing according to the present invention can be performed even at high temperature exceeding 1,500° C. However, even at a temperature of 1,300° C. or less, which is considerably lower than the melting point of zinc oxide, the zinc oxide particles having a polyhedral shape, in which crystallite diameters of the [100] plane and the [101] plane are large regardless of the shape of precursors, can be formed.

According to one embodiment of the present invention, even under conditions of a maximum calcination temperature of 800° C. to 1,400° C., the zinc oxide particles having a polyhedral shape, in which the crystallite diameters of the [100] plane and the [101] plane are large, can be efficiently formed at low cost. Calcining at a maximum temperature of 850° C. to 1,300° C. is more preferable and calcining at a maximum temperature in the range of 900° C. to 1,200° C. is most preferable.

From the viewpoint of production efficiency, a temperature rising rate may be 20° C./min to 600° C./min, ma be 40° C./min to 500° C./min, or mat be 80° C./min to 400° C./min.

With respect to calcination time, calcining is preferably performed under a temperature rising time to the predetermined maximum time in the range of 15 minutes to 10 hours and a holding time at the maximum calcination temperature in the range of 5 minutes to 30 hours. For the efficient formation of the zinc oxide particles, a calcination holding time of about 10 minutes to about 15 hours is more preferable.

Selecting conditions of a maximum temperature of 1,000° C. to 1,400° C. and a calcination holding time of 10 minutes to 15 hours allows the zinc oxide particles having a polyhedral shape including molybdenum to be easily obtained because these zinc oxide particles are difficult to agglomerate.

Although the atmosphere of the calcining is not particularly limited as long as the effects of the present invention can be obtained. For example, an oxygen-containing atmosphere such as air or oxygen or an inert atmosphere such as nitrogen, argon, or carbon dioxide is preferable. The air atmosphere is more preferable when the cost is considered.

The apparatus for the calcining is not necessarily limited and what is called a calcination furnace can be used. The calcination furnace is preferably constituted of a material that does not react with sublimated molybdenum oxide. Furthermore, a highly sealed calcination furnace is preferably used such that the molybdenum oxide is efficiently used.

[Molybdenum Removal Step]

The method for producing the zinc oxide particles according to the present embodiment may further include a molybdenum removal step of removing at least a portion of molybdenum after the calcining step, if necessary.

In the method for producing the zinc oxide particles according to the present embodiment, controlling the calcination time, the calcination temperature, and the like allows the molybdenum content existing in the surface layer of the zinc oxide particles to be controlled and the molybdenum content and the state of existence of molybdenum in the layer other than the zinc oxide particle surface layer (inner layer) to be also controlled.

Molybdenum may adhere to the surface of the zinc oxide particles. The molybdenum can be removed by washing with water, aqueous ammonia solution, aqueous sodium hydroxide solution, or aqueous acidic solution. The molybdenum may not be removed from the zinc oxide particles. However, at least molybdenum existing on the surface is preferably removed because the intrinsic properties of the zinc oxide can be sufficiently exhibited when the particles are dispersed in a medium to be dispersed based on various binders and adverse effects by molybdenum existing on the surface are not caused.

At this time, the molybdenum content can be controlled by varying as appropriate the concentration and used amount of water, aqueous ammonia solution, aqueous sodium hydroxide solution, and aqueous acidic solution, the washing site and washing time, and the like.

[Grinding Step]

The calcined products obtained through the calcining step does not satisfy the particle diameter range suitable for the present invention due to the agglomeration of the zinc oxide particles in some cases. Therefore, the zinc oxide particles may be ground, if necessary, to satisfy the particle diameter range suitable for the present invention.

The method for grinding the calcined product is not particularly limited. Conventionally known grinding methods such as ball mills, jaw crushers, jet mills, disk mills, spectromills, grinders, and mixer mills can be applied.

[Classification Step]

The zinc oxide particles are preferably subjected to classification treatment in order to adjust the average particle diameter, to improve the fluidity of the powder, or to control an increase in viscosity when the zinc oxide particles are blended with a binder for forming a matrix. The term “classification step” refers to the operation of grouping particles depending on the size of the particles.

The classification may be either wet classification or dry classification. From the viewpoint of productivity, the dry classification is preferable. In addition to sieve classification, the dry classification includes wind power classification, in which the difference between centrifugal force and fluid drag force is used to classify particles. From the viewpoint of calcification accuracy, the wind power classification is preferable and can be performed using air current classifiers utilizing the Coanda effect, swirling air current classifiers, forced vortex centrifuge classifiers, and semi-free vortex centrifuge classifiers.

The above grinding step and classification step can be performed at the necessary stages. For example, the average particle diameter of the obtained zinc oxide particles can be adjusted by the presence or absence of these grinding and classification and the selection of conditions for these grinding and classification.

With respect to the zinc oxide particles according to the present invention or the zinc oxide particles obtained by the method for producing according to the present invention, the zinc oxide particles having little agglomeration or no agglomeration are preferable from the viewpoint that the zinc oxide particles can easily exhibit their original properties, are superior in their own handling, and have better dispersibility when the zinc oxide particles are used by dispersing in the medium to be dispersed. In the method for producing the zinc oxide particles, when zinc oxide particles having little agglomeration or zinc oxide particles having no agglomeration are obtained without performing the grinding step and classification step described above, the steps described above are not required to be performed and the target zinc oxide particles having the excellent properties can be produced with high productivity, which is preferable.

<Resin Composition>

The resin composition according to the present embodiment contains the zinc oxide particles and a resin.

In the resin composition according to the present embodiment, the zinc oxide particles function as a heat dissipation filler. The zinc oxide particles have a large crystallite diameter of the [100] plane, high crystallinity, and a polyhedral shape, and thus it is conceivable that when the zinc oxide particles are brought into contact with each other in the resin composition, surface contact, which has high thermal conductivity, may occur. Therefore, it is conceivable that higher thermal conductivity can be obtained even with the same filling ratio compared to the resin composition containing spherical zinc particles.

The resin in the resin composition according to the present embodiment may be a thermosetting resin or may be a thermoplastic resin.

(Thermosetting Resin)

The thermosetting resins are resins having properties that can change to be substantially insoluble and infusible when the resin is cured by means of heat, radiation, or catalysts. For example, the resins are known and customary resins used for molding materials and the like. Specific examples of the resins include novolac phenolic resins such as a phenolic novolac resin and a cresol novolac resin; phenolic resins of resol phenolic resins such as an unmodified resol phenolic resin, oil-modified resol phenolic resins modified with paulownia oil, linseed oil, walnut oil, and the like; bisphenol epoxy resins such as a bisphenol-A epoxy resin and a bisphenol-F epoxy resin; novolac epoxy resins such as a fatty chain modified bisphenol epoxy resin, novolac epoxy resin, and cresol novolac epoxy resin; epoxy resins such as a biphenyl epoxy resin and a polyalkylene glycol epoxy resin; resins having triazine rings such as a urea resin and a melamine resin; vinyl resins such as a (meth)acrylic resin and a vinylester resin; unsaturated polyester resins, bismaleimide resins, polyurethane resins, diaryl phthalate resins, silicone resins, resins having benzoxazine rings, and cyanate ester resins, which may be polymers, oligomers, or monomers.

The thermosetting resins described above may be used together with a curing agent. The curing agent used in this step can be used with the thermosetting resin in a known and customary combination. For example, in the case where the thermosetting resin is the epoxy resin, any compounds commonly used as the curing agent can be used. Example of the curing agent include amine-based compounds, amide-based compounds, acid anhydride-based compounds, and phenol-based compounds. Specific examples of the amine-based compounds include diaminodiphenylmethane, diethylenetrimine, triethylenetetramine, diaminodiphenylsulfone, isophoronediamine, imidazole, BF₃-amine complexes, and guanidine derivatives. Specific examples of the amide-based compound include dicyandiamide and a polyamide resin synthesized from a dimer of linolenic acid and ethylenediamine. Specific examples of the acid anhydride-based compounds include phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, and methylhexahydrophthalic anhydride. Specific examples of the phenolic compounds include phenolic novolac resins, cresol novolac resins, aromatic hydrocarbon-formaldehyde resin-modified phenolic resins, dicyclopentadiene-phenol addition resins, phenol aralkyl resin (Xylok resin), polyvalent phenolic novolac resins synthesized from polyhydroxy compounds and formaldehyde represented by resorcin-novolac resins, naphthol aralkyl resins, trimethylolmethane resins, tetraphenylol ethane resins, naphthol novolac resins, naphthol-phenol cocondensation novolac resins, naphthol-cresol cocondensation novolac resins, polyvalent phenolic compounds such as biphenyl-modified phenol resins (polyvalent phenolic compounds in which phenolic rings are linked by bis-methylene groups), biphenyl-modified naphthol resins (polyvalent naphthol compounds in which phenol rings are linked by bis-methylene groups), aminotriazine-modified phenolic resins (polyvalent phenolic compounds in which phenol rings are linked by melamine, benzoguanamine, or the like), and alkoxy group-containing aromatic ring modified novolac resins (polyvalent phenolic compounds in which phenol rings and alkoxy group-containing aromatic rings are linked by formaldehyde). These curing agents may be used singly or in combination of two or more of them.

The blend amount of the thermosetting resin and the curing agent in the resin composition according to the present embodiment is not particularly limited. For example, in the case where a thermosetting resin is the epoxy resin, use of the curing agent in an amount of active groups in the curing agent of 0.7 equivalents to 1.5 equivalents relative to 1 equivalent of the total epoxy groups in the epoxy resin is preferable from the viewpoint of obtained excellent cured product properties.

A curing accelerator may be used as appropriate in combination with the thermosetting resin in the resin composition according to the present embodiment, if necessary. For example, in the case where the thermosetting resin is the epoxy resin, various types of compounds can be used as the curing accelerator. Examples of the curing accelerator include phosphorus-based compounds, tertiary amines, imidazoles, organic acid metal salts, Lewis acids, and amine complex salts.

A curing catalyst can also be appropriately used in combination with the thermosetting resin in the present embodiment, if necessary. Examples of the curing catalyst include a known and customary thermal polymerization initiator or active energy ray polymerization initiator.

<Thermoplastic Resin>

The resin in the resin composition according to the present embodiment is preferably a thermoplastic resin. The thermoplastic resin used in the present embodiment is known and customary resins used for molding materials and the like. Specific examples of the thermoplastic resin include polyethylene resins, polypropylene resins, polymethacrylic resins, polyvinyl acetate resins, ethylene-propylene copolymers, ethylene-vinyl acetate copolymers, polyvinyl chloride resins, polystyrene resins, poly acrylonitrile resins, poly amide resins, polycarbonate resins, polyacetal resins, polyethylene terephthalate resins, polyphenylene oxide resins, polyphenylene sulfide (PPS) resins, polysulfone resins, polyethersulfone resins, polyetheretherketone resins, polyarylsulfone resins, thermoplastic polyimide resins, thermoplastic urethane resins, polyaminobismaleimide resins, polyamideimide resins, polyetherimide resins, bismaleimidetriazine resins, polymethylpentene resins, fluorinated resins, liquid crystal polymers, olefin-vinyl alcohol copolymers, ionomer resins, polyarylate resins, acrylonitrile-ethylene-styrene copolymers, acrylonitrile-butadiene-styrene copolymers, and acrylonitrile-styrene copolymers. At least one thermoplastic resin is selected to be used. A combination of two or more thermoplastic resins, however, may also be used depending on the purpose.

From the viewpoint of excellent dimensional stability and heat resistance, the combination of the epoxy resin and the curing agent or the polyphenylene sulfide (PPS) resin are more preferable as the above resins. Of these resins, the combination of epoxy resin and the curing agent is optimal because the combination provides the best thermal conductivity as an absolute value.

The resin composition according to the present embodiment may contain other formulations, if necessary. In the range where the effects of the present invention are not impaired, external lubricants, internal lubricants, antioxidants, fire retardants, light stabilizers, UV absorbers, reinforcing materials such as glass fibers and carbon fibers, fillers, and various coloring agents may be added. Stress reducing agents (stress relieving agents) such as silicone oils, liquid rubbers, rubber powders, butadiene-based copolymer rubbers such as methyl acrylate-butadiene-styrene copolymers, methyl methacrylate-butadiene-styrene copolymers, and silicone compounds can also be used.

The resin composition according to the present embodiment is obtained by mixing the zinc oxide particles, the resin, and, if necessary, other formulations. The mixing method of these compounds is not particularly limited and these compounds may be mixed by any known and customary methods.

As general procedures in the case where the resin is the thermosetting resin, a liquid composition having fluidity is obtained by sufficiently mixing a predetermined amount of the thermosetting resin, the zinc oxide particles, and, if necessary, other components using a mixer or the like, and thereafter kneading the resultant mixture using three rolls or the like, or a solid composition is obtained by sufficiently mixing a predetermined amount of the thermosetting resin, the zinc oxide particles, and, if necessary other components using a mixer or the like, melting and kneading the resultant mixture using mixing rolls, an extruder, or the like, and cooling. In the case of blending the curing agent, the catalyst, and the like, it suffices if the state of mixing is a state where the thermosetting resin and these formulations are sufficiently and uniformly mixed. A state where the zinc oxide particles are also uniformly dispersed and mixed is more preferable.

Examples of the general procedures in the case where the resin is the thermosetting resin include a method for mixing the thermoplastic resin, the zinc oxide particles, and, if necessary, other components in advance using various mixers such as a tumbler or a Henschel mixer, and thereafter melting and kneading the resultant mixture using a mixer such as a Bunbury mixer, rolls, a Brabender mixer, a single screw kneading extruder, a twin screw kneading extruder, a kneader, or mixing rolls. The temperature of melting and kneading is not particularly limited and is usually in the range of 240° C. to 320° C.

The mixing ratio of the zinc oxide particles to the non-volatile content of the resin in preparing the resin composition according to the present embodiment is not particularly limited. The ratio is preferably selected in the range of 66.7 parts to 900 parts per 100 parts of the non-volatile content of the resin in terms of mass. The content of the zinc oxide particles in the resin composition according to the present embodiment is not particularly limited and is mixed depending on the degree of thermal conductivity required for each application. The content of the zinc oxide particles is 30 parts by volume to 90 parts by volume in 100 parts by volume of the resin composition.

In order to effectively exhibit the function of the zinc oxide particles serving as the thermal conductive filler and to obtain high thermal conductivity, the zinc oxide particles are preferably highly filled. The use of the zinc oxide particles having a content of 40 parts by volume to 90 parts by volume in 100 parts by volume of the resin composition is more preferable. In the case where the resin in the resin composition is the thermosetting resin, the content of the zinc oxide particles is more preferably 60 parts by volume to 85 parts by volume in 100 parts by volume of the resin composition when the flowability of the thermosetting resin is considered

### EXAMPLES

Subsequently, the present invention will be described in more detail with reference to Examples. The present invention, however, is not limited to Examples described below.

### Comparative Example 1

Zinc oxide (ZnO) (a reagent, manufactured by Wako Pure Chemical Industries, Ltd.) was used as zinc oxide particles in Comparative Example 1. A SEM photograph of the zinc oxide particles in Comparative Example 1 is illustrated in FIG. 7. A particle shape was amorphous.

### Comparative Example 2

(Production of Zinc Oxide Particles)

10.0 g of zinc oxide (ZnO) (Wako Reagent) was placed in an aluminum oxide sagger and was subjected to heat treatment under the following conditions.

(Heat Treatment)

A heating furnace SC-2045D-SP manufactured by MOTOYAMA CO., LTD. was used and a temperature was raised from room temperature to 1,100° C. at a temperature rising rate of 300° C./h, retained at 1,100° C. for 10 hours, and thereafter lowered at a temperature lowering rate of 200° C./h.

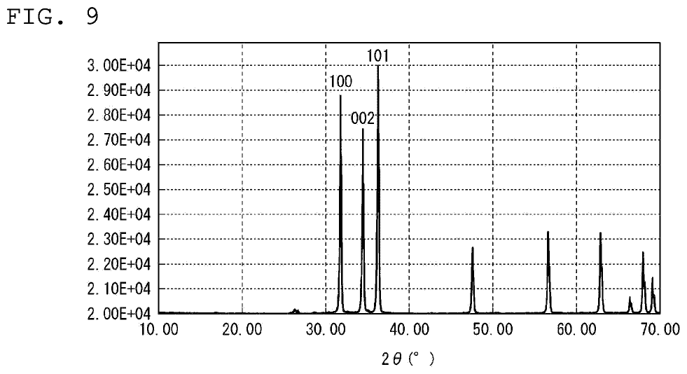

A SEM photograph of the obtained zinc oxide particles in Comparative Example 2 is illustrated in FIG. 8. Compared to the zinc oxide particles in Comparative Example 1, the zinc oxide particles in Comparative Example 2 can be confirmed that the particle diameter becomes larger due to particle growth and the state of the zinc oxide particles in Comparative Example 2 turns into a sintered state. However, the particle shape remained amorphous.

### Example 1

(Production of Zinc Oxide Particles)

10.0 g of zinc oxide (ZnO) (Wako Reagent) and 10.0 g of lithium molybdate (Li₂MoO₄) were placed in a container and the resultant mixture was mixed in a mortar for 10 minutes. The obtained 20.0-g mixture was placed in an aluminum oxide sagger and subjected to heat treatment under the following conditions.

(Heat Treatment)

A heating furnace SC-2045D-SP manufactured by MOTOYAMA CO., LTD. was used and a temperature was raised from room temperature to 1,100° C. at a temperature rising rate of 300° C./h, retained at 1,100° C. for 10 hours, and thereafter lowered at a temperature lowering rate of 200° C./h.

(Post-Processing)

The obtained solid was removed from the sagger and ground coarsely. Thereafter, 150 mL of pure water was added and the obtained mixture was stirred at room temperature for 3 hours to dissolve water-soluble components. The liquid was separated and discarded. The residue was further washed twice with 150 mL of water and the liquid was separated and discarded. Thereafter, the resultant residue was dried at 130° C. for 6 hours.

A SEM photograph of the obtained zinc oxide particles in Example 1 is illustrated in FIG. 1. The zinc oxide particles having a polyhedral shape that was nearly cubic were observed.

### Example 2

(Production of Zinc Oxide Particles)

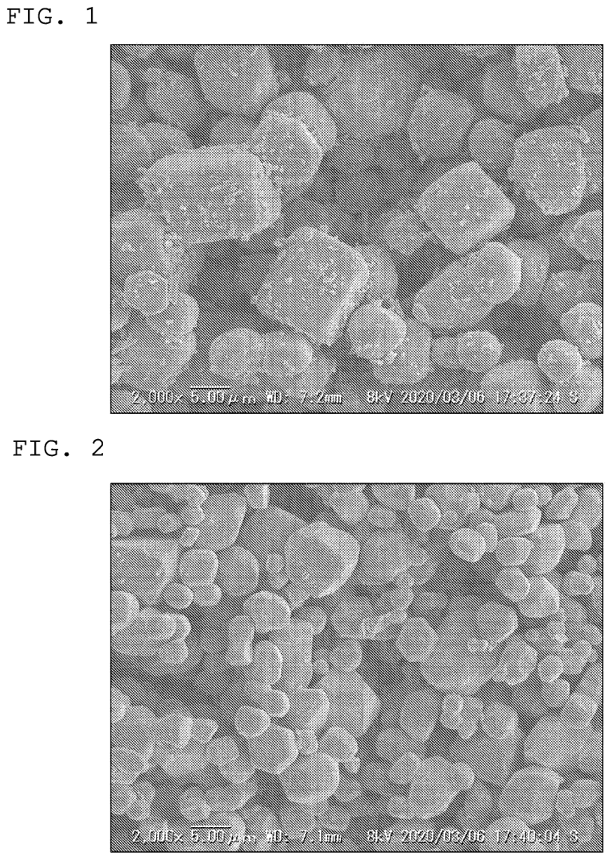

Zinc oxide particles were produced in the same manner as the manner in Example 1 except that 10.0 g of lithium molybdate (Li₂MoO₄) was replaced by 10.0 g of potassium molybdate (K₂MoO₄) in Example 1. A SEM photograph of the obtained zinc oxide particles in Example 2 is illustrated in FIG. 2. The zinc oxide particles having a polyhedral shape were observed.

### Example 3

(Production of Zinc Oxide Particles)

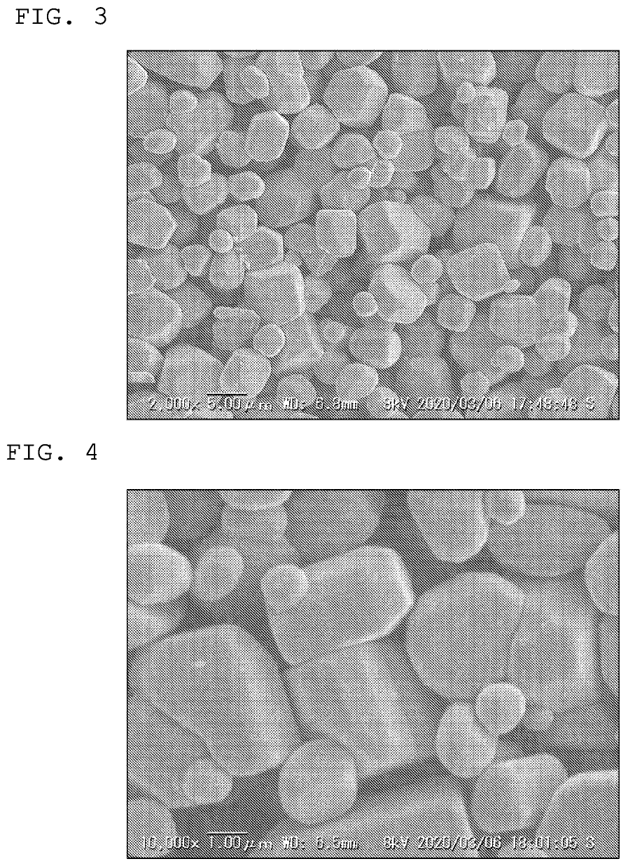

Zinc oxide particles were produced in the same manner as the manner in Example 1 except that 10.0 g of lithium molybdate (Li₂MoO₄) was replaced by 12.0 g of potassium molybdate dihydrate (Na₂MoO₄·2H₂O) in Example 1. A SEM photograph of the obtained zinc oxide particles in Example 3 is illustrated in FIG. 3. The zinc oxide particles having a polyhedral shape were observed.

### Example 4

(Production of Zinc Oxide Particles)

Zinc oxide particles were produced in the same manner as the manner in Example 1 except that, in the heat treatment conditions, the sample was heated from room temperature to 800° C. at a temperature rising rate of 300° C./h and retained at 800° C. for 10 hours in Example 1. A SEM photograph of the obtained zinc oxide particles in Example 4 is illustrated in FIG. 4. The zinc oxide particles having a polyhedral shape were observed.

### Example 5

(Production of Zinc Oxide Particles)

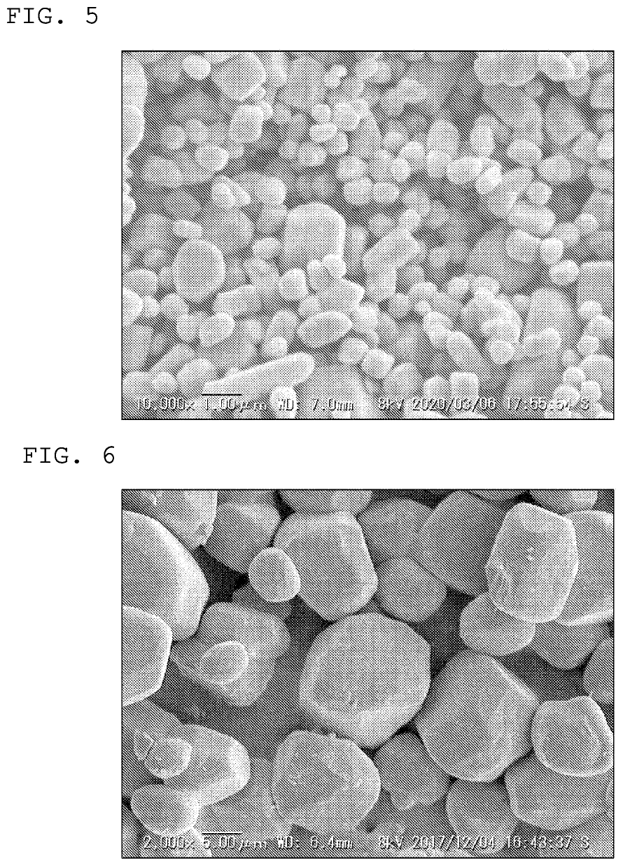

Zinc oxide particles were produced in the same manner as the manner in Example 1 except that, in the heat treatment conditions, the sample was heated from room temperature to 900° C. at a temperature rising rate of 300° C./h and retained at 900° C. for 10 hours in Example 1. A SEM photograph of the obtained zinc oxide particles in Example 5 is illustrated in FIG. 5. The zinc oxide particles having a polyhedral shape were observed.

### Example 6

(Production of Zinc Oxide Particles)

180.0 g of zinc oxide particles (Wako Reagent) and 140.0 g of sodium molybdate dihydrate (Na₂MoO₄·2H₂O) were placed in a container. The resultant mixture was stirred and dispersed sufficiently in an absolute mill for 10 seconds and thereafter scraped off the particles from the wall. This procedure was performed three times. From the resultant product, 21 g of the resultant product was fractionated, placed in an aluminum oxide sagger, and subjected to heat treatment under the following conditions.

(Heat Treatment)

A heating furnace SC-2045D-SP manufactured by MOTOYAMA CO., LTD. was used and a temperature was raised from room temperature to 1,100° C. at a temperature rising rate of 300° C./h, retained at 1,100° C. for 10 hours, and thereafter lowered at a temperature lowering rate of 200° C./h.

(Post-Processing)

The obtained solid was removed from the sagger and ground coarsely. Thereafter, 150 mL of pure water was added and the resultant mixture was stirred for 15 minutes. Thereafter, the mixture was left for 3 hours in an oven heated at 90° C. to dissolve water-soluble components. The liquid was separated and discarded. The residue was further washed twice with 150 mL of water and the liquid was separated and discarded. Thereafter, the resultant residue was dried at 130° C. for 6 hours.

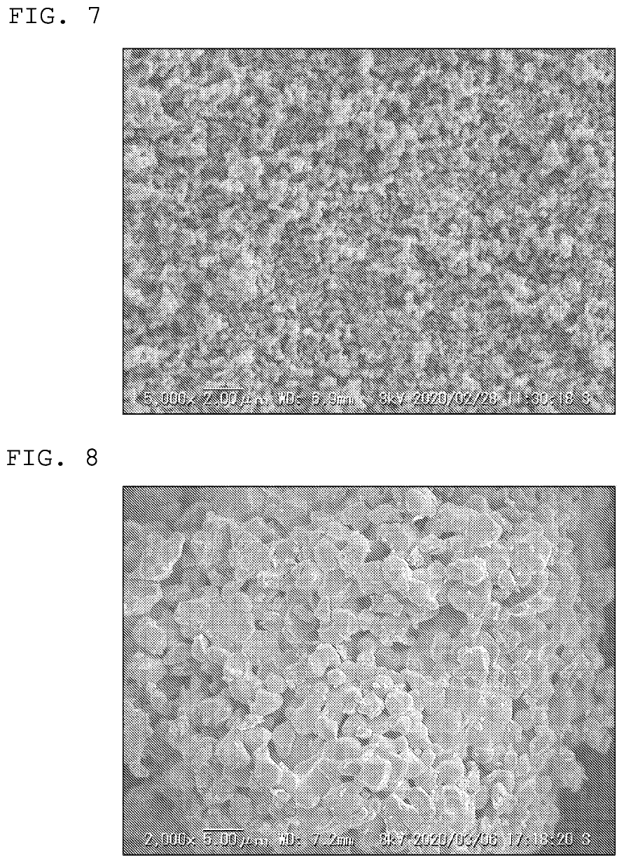

A SEM photograph of the obtained zinc oxide particles in Example 6 is illustrated in FIG. 6. The zinc oxide particles having a polyhedral shape were observed.

The compositions and maximum calcination temperatures of each of the mixtures in Comparative Examples 1 and 2 and Examples 1 to 6 are listed in Table 1.

[Measurement of Average Diameter of Primary Particles of Zinc Oxide Particles]

Zinc oxide particles were photographed by a scanning electron microscope (SEM). A longer diameter (the Feret's diameter of the observed longest part) and a shorter diameter (a short Feret's diameter perpendicular to this Feret's diameter of the longest part) of the particle were measured with respect to the smallest unit of particles (that is, the primary particles) constituting agglomerates on the two-dimensional image, and the average value thereof was determined to be the primary particle diameter. The same operation was performed with respect to randomly selected 50 primary particles and the average diameter of the primary particles was calculated from the average value of the primary particle diameters of these primary particles. The results are listed in Table 1.

[Measurement of Crystallite Diameter]

Using an X-ray diffractometer (SmartLab, manufactured by Rigaku Corporation) equipped with a high-intensity and high-resolution crystal analyzer (CALSA) as a detector, the samples were measured by powder X-ray diffraction (2θ/θ method) under the following measurement conditions. The crystallite diameter of the [100] plane was calculated using the Scherrer's formula from the full width at half maximum (FWHM) of the peak that appears around 2θ=31.8° and the crystallite diameter of the [101] plane was calculated using the Scherrer's formula from the full width at half maximum (FWHM) of the peak appearing around 2θ=36.3° by analysis using CALSA function of analysis software (PDXL) manufactured by Rigaku Corporation. The results are listed in Table 1.

(Measurement Conditions for Powder X-Ray Diffraction Method)

Tube voltage: 45 kV

Tube current: 200 mA

Scanning speed: 0.05°/min

Scanning range: 10° to 70°

Steps: 0.002°

βs: 20 rpm

Instrument standard width: 0.026° calculated using the standard silicon powder (NIST, 640d) produced by the National Institute of Standards and Technology was used.

[Crystal Structure Analysis: XRD (X-Ray Diffraction) Method]

The sample of the zinc oxide particles in Example 1 was filled into a measurement sample holder having a depth of 0.5 mm. The sample holder was set in a wide-angle X-ray diffractometer (XRD) (UltimaIV, manufactured by Rigaku Corporation) and measurements were performed using Cu/Kα rays and under conditions of 40 kV/40 mA, a scan speed of 2°/min, and a scanning range of 10° to 70°. The measurement results of XRD for the zinc oxide particles in Example 1 are illustrated in FIG. 9.

Peaks were observed at 2θ=31.79° ([100] plane), 34.44° ([002] plane), 36.27° ([101] plane), 47.56°, 56.61°, 62.87°, 66.39°, 67.96°, and 69.69°. These peaks can be indexed to the crystal plane of the wurtzite structure of zinc oxide (JSPDF File No. 79-2205).

[Particle Size Distribution Measurement of Zinc Oxide Particles]

Particle size distribution was measured by a dry method using a laser diffraction particle size distribution meter HELOS (H3355) & RODOS, R3: 0.5/0.9-175 μm (manufactured by Japan Laser Corporation) under conditions of a dispersion pressure of 3 bar and a pull pressure of 90 mbar to determine the 10% diameter D₁₀, the median diameter D₅₀, and the 90% diameter D₉₀. In addition, the value of (D₉₀−D₁₀)/D₅₀ was calculated. The results are listed in Table 1.

[Specific Surface Area Measurement of Zinc Oxide Particles]

The specific surface area of the zinc oxide particles was measured using a specific surface area meter (BELSORP-mini, manufactured by Microtrac Bell Co., Ltd.) and the surface area per gram of the sample measured from the adsorbed amount of nitrogen gas by the BET method was calculated as the specific surface area (m²/g). The results are listed in Table 1.

[Purity Determination of Zinc Oxide Particles: XRF (X-Ray Fluorescence) Analysis]

Using an X-ray fluorescence analyzer Primus IV (manufactured by Rigaku Corporation), a sample of about 70 mg of zinc oxide particles was placed on a filter paper and covered with a PP film to perform composition analysis.

The amounts of zinc, the amount of molybdenum, and the amount of sodium determined by XRF analysis were calculated in terms of zinc oxide (ZnO) (% by mass), in terms of molybdenum trioxide (% by mass), and in terms of sodium oxide (Na₂O) (% by mass) relative to 100% by mass of the zinc oxide particles. The results are listed in Table 1.

TABLE 1

| | | | Comparative | Comparative | | | | | | |
|---|---|---|---|---|---|---|---|---|---|---|
| | | | Example 1 | Example 2 | Example 1 | Example 2 | Example 3 | Example 4 | Example 5 | Example 6 |
| ZnO | | g | — | 10.0 | 10.0 | 10.0 | 10.0 | 10.0 | 10.0 | 180.0 |
| | | % by mass | 100.0 | 100.0 | 50.0 | 50.0 | 45.5 | 50.0 | 50.0 | 56.3 |
| Li₂MoO₄ | | g | | | 10.0 | | | 10.0 | 10.0 | |
| | | % by mass | | | 50.0 | | | 50.0 | 50.0 | |
| K₂MoO₄ | | g | | | | 10.0 | | | | |
| | | % by mass | | | | 50.0 | | | | |
| Na₂MoO₄•2H₂O | | g | | | | | 12.0 | | | 140.0 |
| | | % by mass | | | | | 54.5 | | | 43.8 |
| Maximum calcination | | ° C. | — | 1,100 | | | | 800 | 900 | 1,100 |
| temperature | | | | | | | | | | |
| Average particle | (SEM) | μm | <1 | 30 | 10 | 10 | 10 | 1.1 | 2 | 15 |
| Crystallite | [100]Plane | nm | 145 | 191 | 323 | 246 | 280 | 208 | 304 | 269 |
| diameter | 31.8° | | | | | | | | | |
| | [101]Plane | nm | 146 | 220 | 304 | 259 | 291 | 218 | 275 | 288 |
| | 36.3° | | | | | | | | | |
| Particle | D₁₀ | μm | 0.4 | 2.0 | 3.7 | 3.2 | 3.6 | 0.5 | 0.2 | 7.6 |
| size | D₅₀ | μm | 1.2 | 6.7 | 8.3 | 7.3 | 7.5 | 1.5 | 3.9 | 15.5 |
| | D₉₀ | μm | 4.4 | 15.4 | 12.0 | 11.8 | 11.9 | 4.0 | 6.6 | 28.3 |
| | (D₉₀ − | — | 3.3 | 2.0 | 1.0 | 1.2 | 1.1 | 2.4 | 1.7 | 1.3 |
| | D₁₀)/D₅₀ | | | | | | | | | |
| Specific | (BET) | m²/g | 4.10 | 0.18 | 0.33 | 0.35 | 0.35 | 1.20 | 0.71 | 0.10 |
| surface | | | | | | | | | | |
| XRF | ZnO | % by mass | 100 | 100 | 98 | 100 | 100 | 100 | 99.9 | 94.6 |
| Analysis | MoO₃ | % by mass | 0 | 0 | 1.84 | 0 | 0 | 0 | 0 | 0.31 |
| | Na₂O | % by mass | 0 | 0 | 0 | 0 | 0 | 0 | 0 | 5.1 |

### Example 7

7.29 parts by mass of polyphenylene sulfide resin (DIC-PPS LR100G) manufactured by DIC Corporation as the thermoplastic resin and 20.2 parts by mass of the zinc oxide particles in Example 6 were uniformly dry-blended. Thereafter, the resultant mixture was subjected to melting and kneading treatment using a melting and kneading apparatus MC15 manufactured by Xplore Instruments BV. at a mixing temperature of 300° C. and a rotation speed of 100 rpm to give a polyphenylene sulfide resin composition in Example 7 having a filling ratio of 40% by volume of the zinc oxide particles serving as the thermal conductive filler.

### Comparative Example 3

A polyphenylene sulfide resin composition in Comparative Example 3 having a filling ratio of 40% by volume of aluminum oxide particles serving as the thermal conductive filler was obtained in the same manner as the manner in Example 7 except that, in Example 7, 20.2 parts by mass of the zinc oxide particles in Example 6 were replaced by 13.43 parts by mass of spherical aluminum oxide particles (DAW-07) manufactured by DENKA CORPORATION.

### Comparative Example 4

A polyphenylene sulfide resin composition in Comparative Example 4 having a filling ratio of 40% by volume of the zinc oxide particles serving as the thermal conductive filler was obtained in the same manner as the manner in Example 7 except that, in Example 7, 20.2 parts by mass of zinc oxide particles in Example 6 were replaced by 20.2 parts by mass of zinc oxide (ZnO) (Wako Reagent) in Comparative Example 1.

(Preparation of Injection Molded Product)

The respective polyphenylene sulfide resin composites in Example 7 and Comparative Examples 3 and 4 were molded using an injection molding machine IM12 manufactured by Xplore Instruments BV. at a composition temperature of 320° C., a mold temperature of 140° C., an injection pressure of 10 bar, and a holding pressure of 11 bar to give respective dumbbell-shaped 5A test specimens (a width at an edge part of 12.5 mm, a total length of 75 mm, and a thickness of 2 mm) of Example 7 and Comparative Examples 3 and 4 in accordance with JIS K7161-2.

(Heat Dissipation Evaluation)

In accordance with JIS R 1611, heat dissipation test specimens having a size of 10 mm×10 mm×2 mm were cut out from the respective dumbbell-shaped 5A test specimens of Example 7 and Comparative Examples 3 and 4 and thermal diffusivity and specific heat were measured at 25° C. using a thermal conductivity measurement apparatus (LFA467 HyperFlash, manufactured by NETZSCH GmbH & Co. Holding KG). Subsequently, the densities of these heat dissipation test specimens were measured using the Archimedes method. The thermal conductivity of the heat dissipation test specimen was calculated from the product of the obtained thermal diffusivity, specific heat, and density. The results are listed in Table 3.

(Abrasion Resistance Evaluation)

Abrasion resistance test specimens having a size of 10 mm×10 mm×2 mm were cut out from the respective dumbbell-shaped 5A test specimens of Example 7 and Comparative Examples 3 and 4.

To these abrasion resistance test specimens, an alloy tool steel (SKS2) cutter was pressed at a load of 1 kg such that the cutter blade was perpendicularly touched to the square surface of the abrasion resistance test specimen of 10 mm×10 mm. The direction of the cutter blade is parallel to one side of the square having a size of 10 mm×10 mm and the contact length of the cutter blade to the abrasion resistance test specimen is 10 mm.

Subsequently, when the cutter blade was scraped 1,000 reciprocating motions under the conditions of 100 mm travel distance per reciprocating motion and a speed of 75 mm/s, the cutter blade gradually became shorter from an initial blade face height H₀ (80 μm) due to abrasion. A blade face height H₁ after scraping the blade for 1,000 reciprocating motions was measured.

The ratio of the blade face height H₁ after the test to the initial blade face height H₀ (80 μm), that is, an abrasion test retention rate R (%) was determined by the following formula (2).

R (%)=H₁/H₀×100 (2)

As the amount of abrasion of the cutter blade becomes larger, the value of the abrasion test retention rate R (%) becomes smaller. The results are listed in Table 2.

TABLE 2

| | | | Comparative | Comparative |
|---|---|---|---|---|
| | Unit | Example 7 | Example 3 | Example 4 |
| Thermal conductivity | W/mK | 1.6 | 1.1 | 1.2 |
| Abrasion test | % | 78 | 28 | 80 |
| retention rate | | | | |

The injection molded product obtained from the polyphenylene sulfide resin composition in Example 7 containing the zinc oxide particles in Example 6 according to the present invention exhibited superior thermal conductivity to the injection molded product obtained from the polyphenylene sulfide resin composition in Comparative Example 3 containing the aluminum oxide particles and the injection molded product obtained from the polyphenylene sulfide resin composition in Comparative Example 4 containing the zinc oxide particles in Comparative Example 1.

The injection molded products obtained from the polyphenylene sulfide resin composition in Example 7 containing the zinc oxide particles in Example 6 according to the present invention exhibited reduction in risk about the abrasion of counterpart metal materials compared with the injection molded product obtained from the polyphenylene sulfide resin composition in Comparative Example 3 containing the aluminum oxide particles.

### INDUSTRIAL APPLICABILITY

The zinc oxide particles according to the present invention can be used as heat dissipation fillers, paints, and pigments for cosmetics. The zinc oxide particles according to the present invention are particularly expected to be used as fillers for, for example, heat-dissipating compounds for polyphenylene sulfide (PPS), heat-dissipation molded products, sheets for thermal interface materials (TIM), heat-dissipation adhesive materials, heat-dissipation adhesive sheets, heat-dissipation pastes for printed circuit boards (PCB), highly flexible heat-conductive rubbers, heat-dissipation greases, heat-dissipation sealants, and semiconductor sealing resins.

1. A zinc oxide particle having a polyhedral shape, wherein a crystallite diameter of a [100] plane of the zinc oxide particle is 200 nm or more.

2. The zinc oxide particle according to claim 1, wherein a crystallite diameter of a [101] plane of the zinc oxide particle is 250 nm or more.

3. The zinc oxide particle according to claim 1, wherein a median diameter D₅₀ of the zinc oxide particle calculated by a laser diffraction and scattering method is 0.1 μm to 100 μm.

4. The zinc oxide particle according to claim 1, wherein a dispersion index S calculated by following formula (1) from a 10% diameter D₁₀, a median diameter D₅₀, and a 90% diameter D₉₀ calculated by a laser diffraction and scattering method is 2.0 or less:
S=(D₉₀−D₁₀)/D₅₀ (1).

5. A method for producing the zinc oxide particle according to claim 1, the method comprising: calcining a zinc compound in presence of a molybdenum compound.

6. The method for producing the zinc oxide particle according to claim 5, comprising mixing the zinc compound and a molybdate compound to form a mixture and calcining the mixture.

7. The method for producing the zinc oxide particle according to claim 6, wherein the molybdate compound is lithium molybdate, potassium molybdate, or sodium molybdate.

8. A resin composition comprising:
the zinc oxide particle according to claim 1; and
a resin.

9. The resin composition according to claim 8, wherein the resin is a thermoplastic resin.

10. The zinc oxide particle according to claim 2, wherein a median diameter D₅₀ of the zinc oxide particle calculated by a laser diffraction and scattering method is 0.1 μm to 100 μm.

11. The zinc oxide particle according to claim 2, wherein a dispersion index S calculated by following formula (1) from a 10% diameter D₁₀, a median diameter D₅₀, and a 90% diameter D₉₀ calculated by a laser diffraction and scattering method is 2.0 or less:
S=(D₉₀−D₁₀)/D₅₀ (1).

12. The zinc oxide particle according to claim 3, wherein a dispersion index S calculated by following formula (1) from a 10% diameter D₁₀, a median diameter D₅₀, and a 90% diameter D₉₀ calculated by a laser diffraction and scattering method is 2.0 or less:
S=(D₉₀−D₁₀)/D₅₀ (1).

13. A method for producing the zinc oxide particle according to claim 2, the method comprising: calcining a zinc compound in presence of a molybdenum compound.

14. A method for producing the zinc oxide particle according to claim 3, the method comprising: calcining a zinc compound in presence of a molybdenum compound.

15. A method for producing the zinc oxide particle according to claim 4, the method comprising: calcining a zinc compound in presence of a molybdenum compound.

16. The method for producing the zinc oxide particle according to claim 13, comprising mixing the zinc compound and a molybdate compound to form a mixture and calcining the mixture.

17. The method for producing the zinc oxide particle according to claim 16, wherein the molybdate compound is lithium molybdate, potassium molybdate, or sodium molybdate.

18. A resin composition comprising:
the zinc oxide particle according to claim 2; and
a resin.

19. A resin composition comprising:
the zinc oxide particle according to claim 3; and
a resin.

20. A resin composition comprising:
the zinc oxide particle according to claim 4; and
a resin.
